(19) United States
(12) Patent Application Publication
(10) Pub. No.: US 2015/0377667 A1
(43) Pub. Date: Dec. 31, 2015

(54) VIRTUAL MULTIPHASE FLOW METERING AND SAND DETECTION

(71) Applicant: Saudi Arabian Oil Company, Dhahran (SA)

(72) Inventors: TALHA JAMAL AHMAD, Dhahran (SA); Michael John Black, Dhahran (SA); Mohamed Nabil Noui-Mehidi, Dhahran (SA)

(21) Appl. No.: 14/735,217

(22) Filed: Jun. 10, 2015

Related U.S. Application Data
(60) Provisional application No. 62/018,727, filed on Jun. 30, 2014.

(51) Int. Cl. G01F 1/66; G01N 29/14; G01F 1/74

(52) U.S. Cl. CPC G01F 1/66; G01F 1/74; G01N 29/14

(57) ABSTRACT

Virtual and non-invasive multiphase metering is performed for recognition of multiphase flow regimes of hydrocarbons and other fluids, flow rate, presence of sand, and other multiphase flow parameters. A passive acoustical detector system receives acoustical flow information in the form of acoustic emission signals, and a data processor processes and classifies the acoustical patterns. A statistical signal processing methodology is used. Acoustic models are provided for various flow regimes and flow patterns, using Artificial Intelligence methods including Hidden Markov Models and Artificial Neural Networks along with automated learning procedures. The metering can be used for downhole, top side and surface applications.

This application claims priority from U.S. Provisional Application No. 62/018,727, filed Jun. 30, 2014. For purposes of United States patent practice, this application incorporates the contents of the Provisional Application by reference in entirety.

### BACKGROUND OF THE INVENTION

1. Field of the Invention

The present invention relates to virtual and non-invasive multiphase metering with acoustic emission measurements for automated recognition of multiphase flow regimes of hydrocarbons and other fluids in downhole, top side and surface applications, and to metering flow rates, presence of sand, and other parameters of such flow regimes.

2. Description of the Related Art

The simultaneous flow of two or more phases is termed multiphase flow. The flow behavior of multiphase flow is much more complex than for single phase flow and flow regime or flow pattern in a multiphase flow depends on a number of factors including the relative density ratio of one fluid to the other, difference in viscosity between fluids, and velocity (slip) of each fluid. The term fluid flow can include oil, water, gas and solid (sand). Measurement of multiphase flow parameters in hydrocarbon flow regimes and the presence of sand in flow are significantly important in order to optimize production and to determine if sand is produced in the wellbore.

Many methods have been proposed for noninvasive measurement of multiphase flow parameters. These parameters include flow regime, flow rate, presence of solid content, volume and mass ratio of individual phases. One such method has been through active systems that transmitted acoustic/ultrasound frequency in the flow and analyzed the received acoustic response, such as U.S. Pat. No. 6,672,131 and U.S. Pat. No. 7,775,125.

U.S. Pat. No. 5,415,048 implemented a combination of non-invasive vibrational response and flow coupled pressure measurement to ascertain flow. In addition, U.S. Pat. No. 5,415,048 used the characteristic acoustic frequency of the pipe and the amplitude variation, in conjunction with a differential pressure measurement, to obtain the total mass flow rate and mass flow rate of each phase. U.S. Pat. No. 6,575,043 characterized flow by generating acoustic waves in the wall of the conduit. Attenuation of various acoustic wave modes that had entirely propagated within the wall were measured and analyzed to determine distribution of the phases in the flow. U.S. Pat. No. 6,412,352 used an accelerometer attached to a pipe carrying multiphase fluid. The signal produced by the accelerometer was analyzed for a non-intrusive measurement of mass flow rate of the multiphase fluid.

U.S. Pat. No. 7,562,584 involved a non-invasive and passive, fluid flow measurement system, based on mechanical amplification and analysis of acoustic characteristics of multiphase flow in the frequency range of 1 Hz to 15 KHz. Also, quantitative flow data and qualitative data such as change in alarms and states can be determined and transmitted wirelessly to a remote location. U.S. Pat. No. 5,353,627 also utilized an entirely passive acoustical detector means to determine flow regime in a closed pipeline system. The acoustical pattern detected was amplified and compared to known patterns to identify the flow regime according to its acoustical fingerprint. The analyzed frequency range was less than 25 KHz.

Non-invasive methods which utilized acoustic emission to identify various flow regimes and presence of solid content employed various parameters from flow acoustic data such as signal amplitude, rms value, energy and basic frequency content in the signal, and used thresholding and/or template matching techniques. One of the challenges faced with such methods has been the presence of continuous and random background acoustic and electric noise in the system and very low signal-to-noise ratio (SNR) and stochastic nature of acoustic emission signals. Because of this, most of these methods have been unable to provide accurate measurements in practical scenarios for hydrocarbon flow regimes, especially in a downhole environment in which many interrelated factors can affect the acoustics of multiphase flow in a complex manner. Also these methods did not account for acoustic variabilities and the non-stationary nature of the acoustic emission signal. Other deficiencies included intrusiveness, high power consumption, use of radioactive sources, high cost, high complexity and large physical size for downhole applications.

### SUMMARY OF THE INVENTION

Briefly, the present invention provides a new and improved apparatus for determining flow parameters of multiphase flow of fluids in a flow conduit. The apparatus includes a transducer which senses acoustic emissions from the multiphase flow in the flow conduit, and a converter transforming the sensed acoustic emissions into digital acoustic emission signals. The apparatus also includes a computer which has a data memory storing a database of acoustic models of flow regime data in the flow conduit. The computer also includes a processor which forms measures of the flow parameters from the digital acoustic emission signals and the acoustic models of the flow regime data to determine an acoustic model of the flow parameters of the multiphase flow. The processor performs computer implemented steps of segmenting the sensed acoustic emission signals into a sequence of digital acoustic emission segments, determining a feature vector for the digital acoustic emission segments of the sequence of digital acoustic emission segments, and processing the feature vectors to determine a model of flow parameters of the multiphase flow.

The present invention also provides a new and improved computer implemented method of determining with a processor of the computer flow parameters of multiphase flow of fluids in a flow conduit based on acoustic emissions from the multiphase flow and acoustic models of flow regime data in the conduit stored in a database of the computer. The computer implemented is accomplished by segmenting the acoustic emission signals into a sequence of digital acoustic emission segments, and determining a feature vector for each of the sequence of digital acoustic emission segments. The feature vectors are then processed to determine a model of flow parameters of the multiphase flow.

The present invention also provides new and improved data processing system for determining flow parameters of multiphase flow of fluids in a flow conduit based on acoustic emissions from the multiphase flow. The data processing includes a data memory which stores a database of acoustic models of flow regime data in the flow conduit. The data processing system also includes a processor which a processor which segments the acoustic emission signals into a sequence of digital acoustic emission segments. The processor also determines a feature vector for each of the sequence of digital acoustic emission segments, and processes the feature vectors to determine a model of flow parameters of the multiphase flow.

The present invention also provides new and improved data storage device which has stored in a non-transitory computer readable medium computer operable instructions for causing a data processing system to determine in a processor of the computer flow parameters of multiphase flow of fluids in a flow conduit based on acoustic emissions from the multiphase flow and acoustic models of flow regime data in the flow conduit. The instructions stored in the data storage device cause a processor in the data processing system to segment the acoustic emission signals into a sequence of digital acoustic emission segments, and determine a feature vector for each of the sequence of digital acoustic emission segments. The instructions also cause the processor to determine from the feature vectors a model of flow parameters of the multiphase flow.

### BRIEF DESCRIPTION OF THE DRAWINGS

FIG. 1 is a schematic diagram of an apparatus for multiphase flow metering and sand detection according to the present invention.

FIG. 2 is a schematic diagram of a multiphase metering module according to the present invention.

FIG. 3 is a schematic diagram of Hidden Markov modeling topology and associated Gaussian distribution factors for a succession of events, such as acoustic emissions according to the present invention.

FIG. 4 is a functional block diagram of the methodology of constructing an acoustic emission model with Hidden Markov modeling according to the present invention.

FIG. 5 is a functional block diagram of a flow chart of data processing steps for constructing an acoustic model based on an acoustic emission signal according to the present invention.

FIG. 6 is a functional block diagram of a flow chart of data processing steps for parameter optimizing during multiphase flow metering and sand detection according to the present invention.

FIG. 7 is a functional block diagram of a flow chart of data processing steps for multiphase flow metering and sand detection based on an acoustic emission signal according to the present invention.

FIG. 8 is a schematic diagram of processing modules for virtual multiphase flow metering with Artificial Neural Networks according to the present invention.

FIG. 9 is a schematic diagram of Artificial Neural Network architecture of the processing module of FIG. 5.

FIG. 10 is a functional block diagram of a flow chart of data processing steps for multiphase flow metering and sand detection with Artificial Neural Networks based on an acoustic emission signal according to the present invention.

### DETAILED DESCRIPTION OF THE PREFERRED EMBODIMENTS

### Acoustic Emission

According to the present invention, acoustic emission in multiphase flow is defined as a physical phenomenon of acoustic energy occurring within and/or on the surface of flow of mixtures of hydrocarbon oil and gas; water; and sand. An acoustic emission results from spontaneous release of elastic energy in a broad frequency range of 1 KHz to 100 MHz, but most released energy is within a frequency range of from 1 kHz to 1 MHz. Acoustic emission can generate from a number of sources, including:
(a) Bubble formation, breakage and coalescence;
(b) Turbulence noise produced by flow eddies and vortices;
(c) Liquid, gas and solid interaction in a multiphase flow;
(d) Broadband turbulence energy resulting from high flow vortices; and
(e) Intermittent and transient energy variation and fluctuations caused by cavitation, flashing and recirculation.

A number of investigations have been made in studying the sound or in higher frequencies elastic energy emitted from multiphase flow as a function of bubble size and bubble population for various flow regimes. It is established that acoustic energy emitted from multiphase flow is a direct consequence of gas bubble formation, breakage and coalescence, and interaction of various phases within a multiphase flow. Further, the acoustic energy varies for different multiphase flow regimes, flow rates and also with the amount of solid content in the flow. The present invention provides for virtual flow modeling by sensing acoustic energy data and processing such data.

According to the present invention, the term “virtual metering” or “virtual multiphase metering” refers to a metering technique/technology as described herein in which various flow parameters are measured without any active and direct flow measurement method or apparatus. Flow parameters are determined according to the present invention from a group of passive measurements such as pressure, temperature and acoustic emissions, as will be described below.

### Hardware Architecture

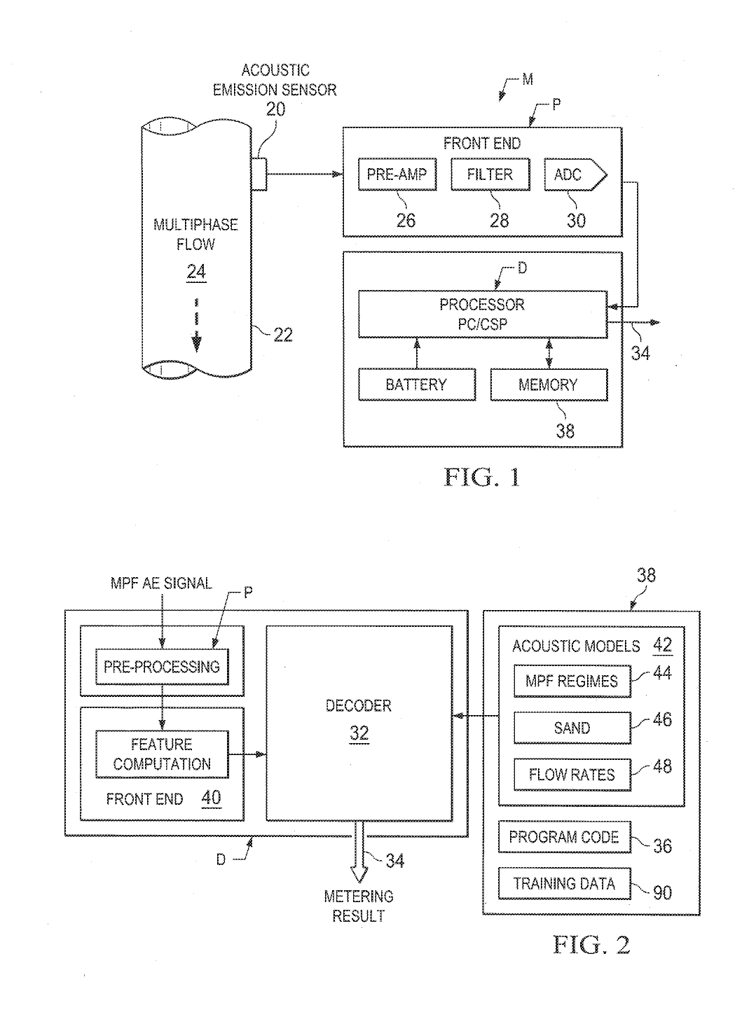

As shown in FIG. 1, an apparatus M for multiphase flow virtual modeling according to the present invention includes an acoustic emission sensor or microphone as a transducer mounted on a pipe, tubing or other flow conduit 22 through which multiphase flow for a hydrocarbon/water mixture to be metered is occurring as indicated at 24. The flow conduit 22 may be one utilized in exploration, production of transport of hydrocarbons, such as for what are known as downhole, top side and surface applications.

The transducer 20 receives multiphase flow acoustic emission signals resulting from the multiphase flow with frequencies from 1 kHz to 1 MHz in order to capture acoustic emissions from such flow. A commercially available acoustic emission sensor/transducer can be used such as AE1045S from Vallen Systems or wideband AE sensor WSA from Mistras Group Ltd. It should be understood that other commercially available transducers may also be used, if desired. Sensors are available for a frequency range from 1 KHz to 2-3 MHz.

The signal captured by the acoustic emission sensor 20 is a combination of multiphase flow acoustic information and random background acoustic noise. A couplant is applied to couple the sensor 20 with flow pipe 22. Typically, a glycerol or oil based couplant is used. The acoustic emission sensor 20 converts the acoustic signal to an electrical signal which is amplified using a preamplifier 26 of a front end preprocessor P. The amplified signal from preamplifier 26 representing the sensed acoustic emission is filtered in a suitable filter 28 and converted to a digitized acoustic emission signal using a high resolution sigma delta analog-to-digital or A/D converter 30.

The converted digital acoustic emission signal from A/D converter 30 is received by a data processor D. The data processor D may be a programmed personal computer (or PC) or it may be a dedicated special purpose digital signal processor (or DSP). The data processor D may be any conventional type of processor with suitable processing and memory capacity such as a laptop computer, tablet or other suitable digital data processing apparatus.

The data processor D includes a multiphase metering (MPM) software module 32 to process, analyze and classify the acoustic signals and provide the metering results. The raw data, acoustic models, and the measurement results can be stored as a database in a memory for future analysis. The processed results from module 32 are available as indicated at 34 for analysis on a suitable display or plotter, or as will be set forth, may be transferred to a wireless communication module for transmission to another computer for study and analysis.

As mentioned, the apparatus M can include an output display and/or user interface if required. For example, in case of a surface or wellhead installation, the apparatus M can include an output display to display the metering results.

The apparatus M may also include a user interface if any modifications in the system are required. Examples include a user interface to access data processor D, to update the multiphase metering software module 32 or frontend module 40 if required. A user interface may also be used to access and/or update acoustic models 42, program code 36 or training data 90 in memory 38.

The processor D accesses the digitized acoustic emission signals from the converter 28 to perform the processing logic and methodology of the present invention, which may be executed as a series of computer-executable instructions. The instructions may be contained as program code 36 in memory 38 (FIG. 2) as a computer readable medium. The instructions may also be stored in the form of conventional hard disk drive, electronic read-only memory, computer diskette, or on magnetic tape, optical storage device, or other appropriate data storage device.

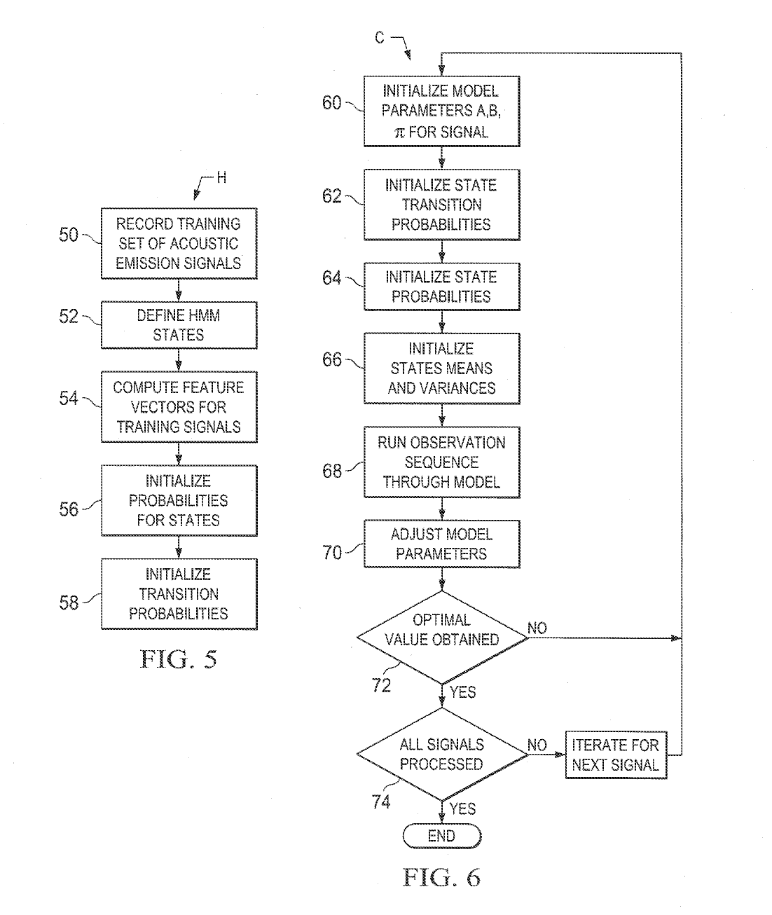

The flow charts of FIGS. 5, 6, 7 and 10 herein illustrate the structure of the logic of processing according to the present invention as embodied in computer program software. Those skilled in the art will appreciate that the flow charts illustrate the structures of computer program code elements including logic circuits on an integrated circuit that function according to this invention. It is thus apparent that the invention is practiced in its preferred embodiment by a machine component that renders the program code elements in a form that instructs a digital data processing apparatus to perform a sequence of function steps corresponding to those shown.

The multiphase metering software module 32 is trainable, as will be set forth. According to one embodiment of the present invention, Hidden Markov modeling (HMM) is used as the framework for statistical modeling of flow regimes. Hidden Markov Models are statistical models which output a sequence of symbols or quantities. Hidden Markov Models can be trained automatically and are computationally performable.

Although multiphase acoustic signals are non-linear signals with continuous random noise, according to the present invention they are considered as short time stationary or linear signals. Thus, with the present invention an acoustic emission signal sensed by the sensor 20 after conversion into digital format is divided or segmented into small segments of a specified duration, typically of 50-200 ms. For the purposes of the present invention, it is assumed that the acoustic emission signal is linear within each such time segment. Feature vectors are computed for each stationary segment and a Hidden Markov Model is created and trained using these feature vectors. In order to deal with variability due to presence of continuous random noise, a Hidden Markov Model for each flow type is created and trained using a large amount of acoustic training data collected from laboratory flow loop setups and/or field data.

### Multiphase Metering Module

The Multiphase Metering software module 32 (FIG. 2) is implemented in software, and receives flow data from a frontend module 40 for preprocessing and feature computation, and also data from a comprehensive model library or database 42 of stored flow regime data. The stored data in model library 42 takes the form of acoustic models obtained from laboratory and field data for various flow types, including multiphase flow regime models as indicated schematically at 44, sand content as indicated at 46, and flow rates as indicated at 48. The Multiphase Metering software module 32 is configured as a decoder which recognizes the acoustical pattern and identifies various parameters including flow regime, flow rate and solid content.

The frontend module 40 provides the acoustical observations of a particular flow segment. These observations are feature vectors that are considered to represent acoustic characteristics of flow. For training as well as detection, feature vectors are extracted from acoustic signals. During pre-processing stage, continuous acoustic emission acoustic signals are segmented and split into overlapping segments of 50-200 ms, and windowing is performed on each segment. Windowing is performed in order to reduce the energy at the edges and decrease the discontinuities at the edges of each segment. A Hamming window can be used for this purpose, for example. Other windows can also be used including Hanning and Blackman. After pre-processing, feature computation is performed for each segment.

Important acoustic characteristics can include frequency distribution, dominant frequency bands, and dominant energy in frequency bands. Acoustic emission from multiphase flow is a non-stationary process, and thus standard signal processing techniques are not suitable for analysis. Cepstrum coefficients can also be used as feature vectors. The cepstrum coefficient is the result of Fourier analysis of the logarithmic amplitude spectrum of the signal. If the log amplitude spectrum contains many regularly spaced harmonics, then the Fourier analysis of the spectrum exhibits a peak corresponding to the spacing between the harmonics which is the fundamental frequency. Other parameters, such as wavelet transform, which represent the important acoustic characteristics can also be used to compute feature vectors.

In order for multiphase flow virtual modeling apparatus M to measure various flow parameters and sand presence, an acoustic model is formed for each of the various flow types to be encountered. In order to build an accurate acoustic model (Hidden Markov Model) for each of the flow type, training data is acquired from laboratory flow loops and actual field is used. It is beneficial and preferable that a significant amount of such training data be acquired and accumulated.

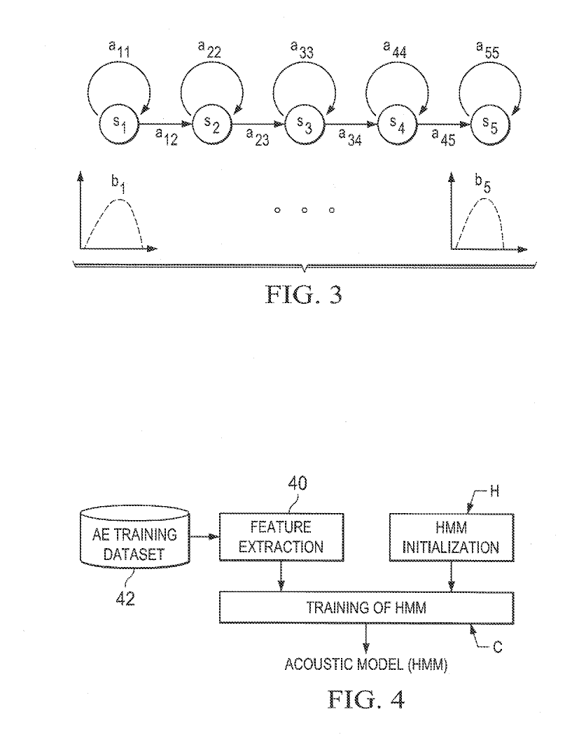

The Hidden Markov Model is essentially modeling a stochastic process defined by a set of states s₁, s₂, s₃, S₄, and s₅ (FIG. 3) and transition probabilities a₁, a₁₂, a₂₂, a₂₃, a₃₃, a₃₄, a₄₄, a₄₅, and a₅₅ between those states, where each state describes a stationary stochastic process, and the transition from one state to another state describes how the process changes its characteristics in time. Each state s₁, s₂, s₃, s₄, and s₅ has a statistical output distribution usually represented by a Gaussian probability distribution function as shown schematically at b₁, through b₅, respectively, which provides likelihood and distribution for each observed feature vector. Various parameters of Hidden Markov Model for a particular flow regime are estimated from training data, preferably using what is known as a Baum-Welch algorithm.

A Hidden Markov Model is formally defined as

λ=(A,B,π)

### Where:

A is a transition array, storing the transition probabilities from one state to other;

B is the observation probability array, storing the probability of observation being produced from the state; and

π is the initial probability array of states.

### Constructing an Acoustic Model for Each Flow Type Using Hidden Markov Model

The methodology for constructing an acoustic model for each flow type using Hidden Markov Model Record according to the present invention is shown schematically in a flowchart H in FIG. 5. As indicated at step 50, a training set is recorded of at least 50 acoustic emission signals representative of the particular flow type, each of 5-10 seconds duration. Size of training data set and length of individual acoustic emission signals can be increased to improve accuracy of acoustic models. The acoustic emission signals can be acquired from laboratory flow loops and/or actual field. Data acquired from surface or downhole conditions can also be stored in memory and used, depending on the target application.

During step 52, the architecture of Hidden Markov Model is defined. A left-right Hidden Markov Model with typically from 5 to 20 states is used. Other numbers of states may also be used, if desired. The number of states depends upon length of each segment and number of segments within a single acoustic emission signal. Hidden Markov Models with different topologies such as Ergodic or Parallel can also be used.

For each training signal, feature vectors are computed during step 54 using the procedure described above. During step 56, probabilities for the states are initialized. An initial probability for the first state is 1, while it is considered 0 for the remaining states. Each of the transition probabilities is initialized with a 0, except the last transition which is initialized with 1.

The statistical output distribution for each state is Gaussian. Global mean and variance are computed as a portion of step 58 of all feature vectors in the complete training acoustic emission training dataset. All Gaussians (i.e., all state output distributions) are then initialized during step 58 with this mean and variance.

After initializing all parameters for a Hidden Markov Model, a Baum-Welch algorithm is preferably used, as is described below, to optimize parameters (A, B, π) and train the Hidden Markov Model using the training data.

### Parameter Optimizing Algorithm

With the present invention, a Baum-Welch algorithm is preferably used to optimize the unknown Hidden Markov Model parameters (A, B, π). The Baum-Welch algorithm is a particular case of a generalized expectation-maximization (GEM) algorithm. The Baum-Welch algorithm is an estimation method based on the Forward-Backward algorithm. A brief description of the algorithm is provided below, while detailed mathematical description can be found in “A maximization technique occurring in the statistical analysis of probabilistic functions of Markov chains”, (Baum1970) and “Hidden Markov Models and the Baum-Welch Algorithm”, IEEE Information Theory Society Newsletter, December 2003.

In order to construct and train a Hidden Markov Model parameter λₐ using training dataset O_{training}, where O_{training} contains a large number (≧50) of acoustic emission feature vectors (observation sequences) for a particular flow type, model parameters for λₐ that would make observations most likely:

arg max_{λ}_{ₐ}P(O_{training}|λₐ)

The optimization is performed in a sequence indicated schematically by a flow chart C (FIG. 6). As indicated at step 60, the model parameters (A, B, π) are initialized in the manner described above. The state transition probabilities are initialized during step 62 and the state probabilities are initialized during step 64. The means and variances of the states are initialized during step 66. Each observation sequence O_{training} (n) is then run through the model during step 68 to estimate the expectation of each model parameter.

In step 70, the model parameters are adjusted or changed such that probability P(O_{training}(n)|λₐ) is maximized. The procedure is then repeated for all training data until step 72 indicates that all model parameters are converged to an optimal value, and the training procedure is repeated until step 74 indicates that for all signals in a dataset are processed.

Once acoustic models (Hidden Markov Models) are thus created for all flow types, the models can be used by the automated decoder module 32 (FIG. 2) to detect and identify a multiphase flow acoustic emission signal in real time using statistical search algorithms.

### Multiphase Flow Metering and Sand Detection

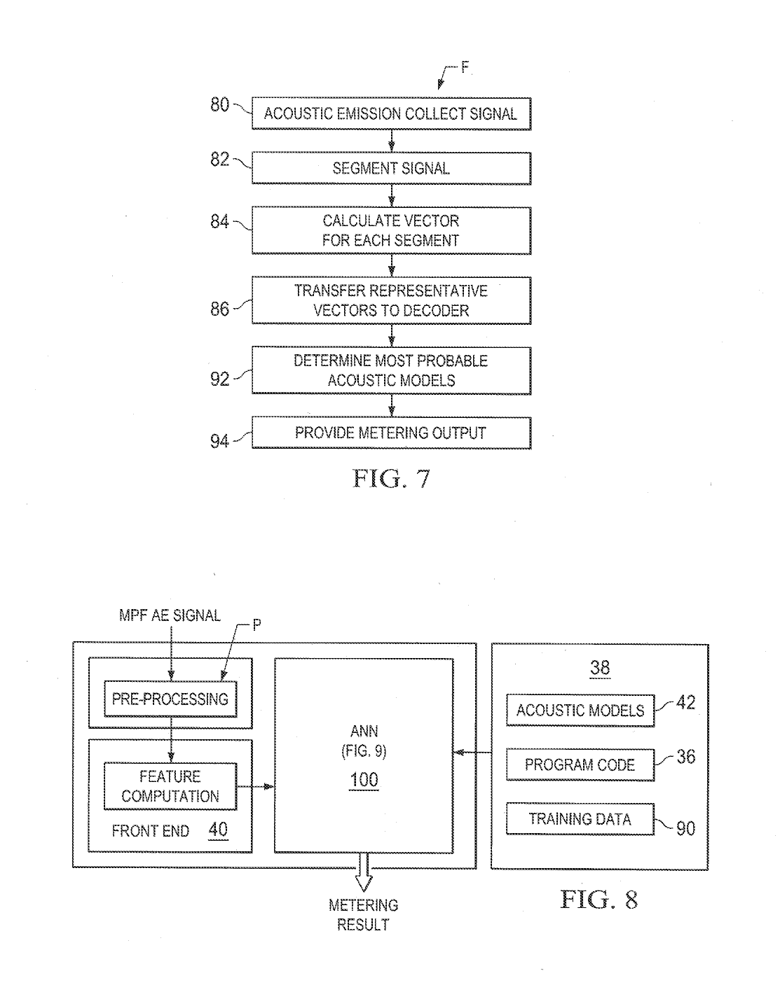

The methodology for multiphase flow metering and sand detection as indicated schematically by a flow chart F (FIG. 7). The multiphase flow acoustic emission signal is sensed by the sensor 20. After being pre-amplified and, the sensed signal is filtered and converted into a digital signal in the A/D converter 30. The digital signal is acquired as indicated in step 80 by the multiphase metering decoder module 32. The software front end 40 segments the signal in step 82, and during step 84 calculates the feature vector for each segment. A sequence of representative feature vectors of an acoustic emission signal is passed during step 86 to decoder 32. A comprehensive library 90 (FIG. 2) of acoustic models (Hidden Markov Model) training data for various flow types is also available to the decoder 32.

A Viterbi algorithm is used during step 92 to find most probable acoustic model(s) to which the currently observed acoustic emission signal belongs. In Viterbi processing, given a library of acoustic models (λ₁, λ₂ . . . ) for various flow types and received acoustic emission feature vector O_{received}, the likelihood of the observed feature vector given the Hidden Markov Model models for all flow types is computed as follows:

P(O_{received}|λ₁),P(O_{received}|λ₂),P(O_{received}|λ₃), . . .

The Viterbi algorithm is a dynamic programming algorithm for finding the most likely sequence of hidden states called the Viterbi path that results in a sequence of observed events. A simplified description of Viterbi algorithm is provided below. Details of the algorithm can be found in G. D. Forney, Jr., “The Viterbi Algorithm,” Proc. IEEE, vol. 61, pp. 268-278, March 1973 and L. R. Rabiner, “A Tutorial on Hidden Markov Models and Selected Applications in Speech Recognition,” Proc. IEEE, vol. 77, pp. 257-286, February 1989.

Given feature vectors (observation sequence) O_{received}, and a Hidden Markov Model λ₁, Viterbi algorithm recursively determines the state sequence Q={q₁, q₂, q₃ . . . } in the model that is optimal. An optimized state sequence is one which best explains the data and probability of this state sequence can be computed, and thus P(O_{received}/λ₁) is calculated. The algorithm is based on the assumption that given an observation sequence, the best path (or best state sequence in the model) is far more likely than any other path, hence P(O_{received}/λ₁)≈P(O_{received},δ/λ₁), where δ is the best path. In every step, only one path is stored while the rest are discarded. The optimal state sequence can be reconstructed by backtracking.

The probable value for observed acoustic emission signal can be high for one or more than one acoustic model. For example, high probability value for acoustic models of both slug flow and low sand content can represent that multiphase flow is slugging with low content of sand in it. Important flow parameters including flow regime, flow rate range and presence of sand can thus be determined from decoder output.

To reduce the effect of random noise and variability on metering in actual downhole or surface conditions, reduction of a mismatch between training and recognition conditions is required. This can be achieved by using actual field data as the training data. Also, acoustic models (Hidden Markov Model parameters) can be optimized for particular metering conditions. In addition, noise spectral properties are expected to be more stationary than those of the acoustic emission, and thus the noise can be compensated by applying spectral subtraction in the spectral domain.

After the most probable acoustic models are determined during step 92 in this manner, the determined results are made available during step 94 as metering results 34 (FIGS. 1 and 2).

### Acoustic Modeling Using Artificial Neural Networks

FIG. 8 illustrates another embodiment for multiphase flow modeling according to the present invention, one in which multiphase flow models are be developed using Artificial Neural Networks or ANN methodology. An Artificial Neural Network or ANN module 100 receives digital input signals after signal preprocessing and analog-to-digital conversion in module P and feature computation in a frontend module 40 as that described for FIG. 2.

As will be described below, the ANN module 100 contains a suitably large number of simple processing neuron-like processing elements (nodes); and a suitably large number of weighted connections between the elements or nodes. The ANN module 100 also obtains in accordance with Artificial Neural Network methodology a distributed representation of knowledge over the connections, the knowledge being acquired by the network in the module 100 through a learning process.

The Artificial Neural Network based multiphase flow metering according to the present invention shown in FIG. 8 preferably is a multilayer feed forward neural network which is used with a Backpropagation algorithm for training.

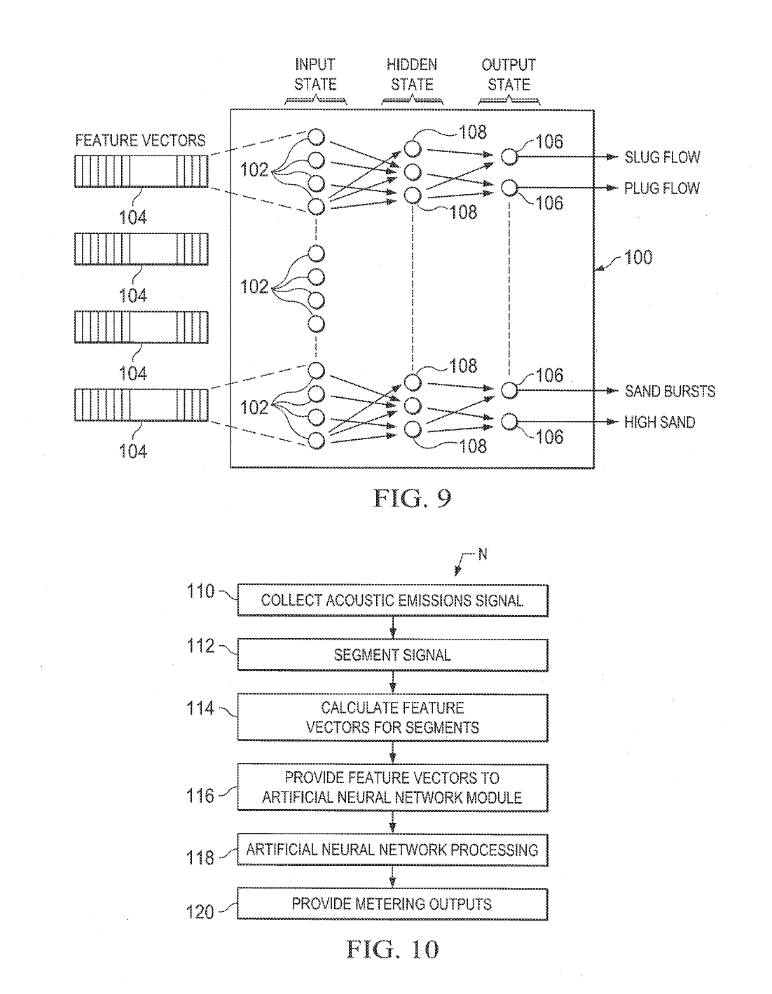

More detailed structure of the Artificial Neural Network module 100 is provided in FIG. 9. A suitable number of nodes 102 in input layers are provided, the number of such nodes depending on the number of feature vectors and length of each vector. Feature vectors 104 for the signal segments are computed using the procedure described above and shown in FIG. 5. A suitable number of output nodes 106 (FIG. 9) are also provided in the Artificial Neural Network module 100. The number of output nodes is determined by the number of flow types or parameters to be developed for the model of multiphase flow. A suitable number of nodes 108 in a hidden layer are also provided, the number depending on the number of input nodes 102 and output nodes 106. The hidden layer nodes take the form of non-linear sigmoidal-activation function neurons.

The Artificial Neural Network module 100 is trained using a large training dataset stored in memory 38 and a Backpropagation algorithm. The training dataset should include fifty or more acoustic emission signals for each type of flow. Once the Artificial Neural Network 100 is trained, it can be used for multiphase flow metering using the same procedure as described for Hidden Markov Models.

### Constructing an Artificial Neural Network

The methodology for constructing an artificial neural network for multiphase flow metering and sand detection as indicated schematically by a flow chart N (FIG. 10). A training set of at least 50 acoustic emission signals representative of the particular flow type, each of 5-10 seconds, is recorded as indicated at 110. The recorded acoustic emission signals can be acquired from laboratory flow loops and/or actual field data. Data acquired from surface or downhole conditions can be used depending on the target application.

As indicated at step 112, the signal is segmented into segments of suitable time length. For each of the training signals, the feature vectors are computed in step 114, using the procedure described above for step 54. In step 116, the feature vectors resulting from step 114 are provided to the Artificial Neural Network Module 100.

Once an Artificial Neural Network is created, it is trained as part of step 118, preferably using a suitable Backpropagation algorithm. An example of such a Backpropagation algorithm for Module 100 is contained in “Parallel Distributed Processing: Explorations in the Microstructure of Cognition”, (Rumelhart and McClelland, 1986). During step 118, feature vectors 104 computed from the training signals are also provided as training input, and their corresponding flow types as output are presented to Artificial Neural Network (supervised learning). The process is repeated with a training set for each flow type. A more detailed description can be found in Alpaydin, Ethem, “Introduction to Machine Learning” (2nd ed.). Cambridge, Mass.: MIT Press, 2010.

As the name indicates, in a Backpropagation algorithm, the errors propagate backwards from the output nodes to the input nodes. Technically speaking, backpropagation calculates the gradient of the error of the network regarding the network's modifiable weights.

### Metering with Artificial Neural Network Modeling

In metering with artificial neural network modeling, the acoustic emission transducer is activated and receives a multiphase flow acoustic emission signal from the multiphase flow for a hydrocarbon/water mixture to be metered in the pipe or conduit 22. The acoustic emission signal is pre-amplified, filtered and converted into a digital signal in hardware front-end module P as described above.

The digital signal from the module P is then received or collected by the multiphase metering software module 32. The processing of the digital signals is indicated schematically in FIG. 10. As indicated at step 112, the software frontend 40 divides or segments the signal and calculates the feature vector for each segment.

As indicated at step 116, a sequence of representative feature vectors of an acoustic emission signal is passed from data storage or memory to Artificial Neural Network module 100 as an input. During step 118, the Artificial Neural Network processing is performed and metering results and flow parameters determined. As indicated at step 120, outputs of the metering results are formed and made available from output nodes 106 for display analysis and evaluation. The metering results are also stored in data memory for further use and analysis.

### Phase Sensitive Detection Front End

The apparatus A shown in FIG. 1 utilizes describes a broadband measurement of the full multiphase flow acoustic emission, although with a certain amount of prefiltering with the filter 28. In situations where the acoustic emission spectrum has a high level of signal to noise ratio, it may be necessary to include a high Q measurement. This can be performed through either:
(a) a single lock-in amplifier channel with a tunable high Q filter where the measured voltage level represents the amplitude of noise at the midpoint frequency of the filter, or
(b) an array of lock-in amplifiers each tuned to a different frequency, each outputting a DC voltage that corresponds with the amplitude of the sound at the midpoint frequency of the filter.

In both such cases, the output from the lock-in amplifier front end provides a quantized approximation of the Fourier transform of the time-dependent multiphase flow acoustic emission. This can be interpolated and directly processed as a sound spectrum, and an inverse Fourier transform can be performed to reconstruct the time dependent behavior or simply directly processed.

During the training phase, the choice of the fixed frequencies of the lock-in amplifier filters can be tuned to relevant frequencies within the sound spectrum to maximize signal recovery and minimize noise and other mechanisms such as reverberation.

The lock in amplifiers can be assembled using standard integrated circuit components and the tunable frequency filter can be achieved either through front end digital signal processing through the use of finite or infinite impulse response filters or through a tunable analog filter.

It is to be noted that use of Hidden Markov Model or Artificial Neural Network based metering does not affect the hardware architecture of the system, as the signal processing and pattern recognition techniques are implemented in a PC/DSP serving as processor D. Thus, multiphase flow metering according to the present invention can have three possible configurations:
(a) Multiphase metering system based on Hidden Markov Model based acoustic modeling;
(b) Multiphase metering system based on Artificial Neural Network based acoustic modeling; or
(c) Multiphase metering system based on both Hidden Markov Model and Artificial Neural Network based acoustic modeling

In a further embodiment of the system, the apparatus M can be integrated with one or more sensor measurements (including differential pressure measurement) to improve accuracy of data. The apparatus M can also be integrated with a wireless communication module to enable the following functions:
(a) Transmit the data to a central location and enable remote operation in case of surface or near wellhead applications; or
(b) Transmit the data to surface or wellhead in case of downhole application.

The present invention thus can be seen to provide a multiphase flow metering solution capable of installation either in surface applications as top sides off-shore or on-shore locations, and also deployable downhole as part of a permanent or retrievable system. The system characteristics allow for compact packaging of the metering system.

The present invention thus utilizes a different approach, statistically modeling the acoustic variations in multiphase flow using advanced signal processing techniques and automated learning procedures to enable accurate multiphase metering. The present invention is based on acoustic emission, the release of elastic energy occurring within and/or on the surface of flow of mixtures of hydrocarbon oil and gas; water; and sand which occurs from multiphase flow.

The present invention is low cost, non-radioactive, ultra-low power, and small size. The present invention is not intrusive, in that it does not require penetration of the pipe wall and thus does not impede the flow. The present invention also does not require an acoustic or radio frequency (RF) excitation signal be generated to pass through the fluid and/or pipe wall. The invention has been sufficiently described so that a person with average knowledge in the matter may reproduce and obtain the results mentioned in the invention herein Nonetheless, any skilled person in the field of technique, subject of the invention herein, may carry out modifications not described in the request herein, to apply these modifications to a determined structure, or in the manufacturing process of the same, requires the claimed matter in the following claims; such structures shall be covered within the scope of the invention.

It should be noted and understood that there can be improvements and modifications made of the present invention described in detail above without departing from the spirit or scope of the invention as set forth in the accompanying claims.

What is claimed is:

1. An apparatus for determining flow parameters of multiphase flow of fluids in a flow conduit, comprising:
(a) a transducer sensing acoustic emissions from the multiphase flow in the flow conduit;
(b) a converter transforming the sensed acoustic emissions into digital acoustic emission signals;
(c) a computer comprising a data memory storing a database of acoustic models of flow regime data in the flow conduit; and
(d) the computer further comprising a processor forming measures of the flow parameters from the digital acoustic emission signals and the acoustic models of the flow regime data to determine an acoustic model of the flow parameters of the multiphase flow, the processor performing the computer implemented steps of:
(1) segmenting the sensed acoustic emission signals into a sequence of digital acoustic emission segments;
(2) determining a feature vector for the digital acoustic emission segments of the sequence of digital acoustic emission segments;
(3) processing the feature vectors to determine a model of flow parameters of the multiphase flow.

2. The apparatus of claim 1, further including the data memory storing a database of actual multiphase flow conditions in the database of acoustic models.

3. The apparatus of claim 2, wherein the processor in processing the feature vectors to determine a model of flow parameters receives as inputs actual multiphase flow conditions data from the database.

4. The apparatus of claim 1, wherein the processor in processing the feature vectors to determine a model of flow parameters performs Hidden Markov modeling.

5. The apparatus of claim 1, wherein the processor in processing the feature vectors to determine a model of flow parameters performs the step of:
determining a model of flow parameters of the multiphase flow based on the determined flow vectors for the sequence of digital acoustic segments and the stored acoustic models of flow regime data in the flow conduit.

6. The apparatus of claim 5, wherein the processor in determining a model of flow parameters determines a most probable model of flow parameters of the multiphase flow based on the determined flow vectors for the sequence of digital acoustic segments and the stored acoustic models of flow regime data in the flow conduit.

7. The apparatus of claim 1, wherein the processor in processing the feature vectors to determine a model of flow parameters performs Artificial Neural Network modeling.

8. The apparatus of claim 1, wherein the processor in processing the feature vectors to determine a model of flow parameters performs the steps of:
(a) receiving the feature vectors as input states for Artificial Neural Network processing;
(b) performing the Artificial Neural Network processing based on the input states to determine flow parameters of the model of multiphase flow; and
(c) providing as output states the determined flow parameters of the model of multiphase flow.

9. The apparatus of claim 1, wherein the processor in processing the feature vectors to determine a model of flow parameters performs Hidden Markov modeling and Artificial Neural Network modeling.

10. The apparatus of claim 1, wherein the processor further forms a training model for performing the step of processing the feature vectors.

11. The apparatus of claim 10, wherein the processor further stores the formed training model in the memory.

12. The apparatus of claim 1, wherein the processor further provides the determined model of flow parameters of the multiphase flow for display.

13. A computer implemented method of determining with a processor of the computer flow parameters of multiphase flow of fluids in a flow conduit based on acoustic emissions from the multiphase flow and acoustic models of flow regime data in the conduit stored in a database of the computer, comprising the computer processing steps of:
(a) segmenting the acoustic emission signals into a sequence of digital acoustic emission segments;
(b) determining a feature vector for each of the sequence of digital acoustic emission segments;
(c) processing the feature vectors to determine a model of flow parameters of the multiphase flow.

14. The computer implemented method of claim 13, wherein the computer data memory stores a database of actual multiphase flow conditions, and wherein the step of processing the feature vectors to determine a model of flow parameters is performed based on actual multiphase flow conditions data from the database.

15. The computer implemented method of claim 13, wherein the step of processing the feature vectors to determine a model of flow parameters comprises Hidden Markov modeling.

16. The computer implemented method of claim 13, wherein the step of processing the feature vectors to determine a model of flow parameters comprises the step of:
determining a model of flow parameters of the multiphase flow based on the determined flow vectors for the sequence of digital acoustic segments and the stored acoustic models of flow regime data in the flow conduit.

17. The computer implemented method of claim 13, wherein the step of processing the feature vectors to determine a model of flow parameters comprises the step of:
determining a most probable model of flow parameters of the multiphase flow based on the determined flow vectors for the sequence of digital acoustic segments and the stored acoustic models of flow regime data in the flow conduit.

18. The computer implemented method of claim 13, wherein the step of processing the feature vectors to determine a model of flow parameters comprises Artificial Neural Network modeling.

19. The computer implemented method of claim 13, wherein the step of processing the feature vectors to determine a model of flow parameters comprises the steps of:
(a) receiving the feature vectors as input states for Artificial Neural Network processing;
(b) performing the Artificial Neural Network processing based on the input states to determine flow parameters of the model of multiphase flow; and
(c) providing as output states the determined flow parameters of the model of multiphase flow.

20. The computer implemented method of claim 13, wherein the step of processing the feature vectors to determine a model of flow parameters comprises Hidden Markov modeling and Artificial Neural Network modeling.

21. The computer implemented method of claim 13, further including the step of forming a training model for performing the step of processing the feature vectors.

22. The computer implemented method of claim 21, further including the step of storing the formed training model in the memory of the computer.

23. The computer implemented method of claim 13, further including the step of providing the determined model of flow parameters of the multiphase flow for display.

24. A data processing system for determining flow parameters of multiphase flow of fluids in a flow conduit based on acoustic emissions from the multiphase flow, the data processing comprising:
(a) a data memory storing a database of acoustic models of flow regime data in the flow conduit; and
(b) a processor performing the steps of:
(1) segmenting the acoustic emission signals into a sequence of digital acoustic emission segments;
(2) determining a feature vector for each of the sequence of digital acoustic emission segments; and
(3) processing the feature vectors to determine a model of flow parameters of the multiphase flow.

25. The data processing system of claim 24, further including the data memory storing a database of actual multiphase flow conditions.

26. The data processing system of claim 24, further including the processor in processing the feature vectors to determine a model of flow parameters receiving as inputs actual multiphase flow conditions data from the database.

27. The data processing system of claim 24, wherein the processor in processing the feature vectors to determine a model of flow parameters performs Hidden Markov modeling.

28. The data processing system of claim 24, wherein the processor in processing the feature vectors to determine a model of flow parameters performs the step of:
determining a model of flow parameters of the multiphase flow based on the determined flow vectors for the sequence of digital acoustic segments and the stored acoustic models of flow regime data in the flow conduit.

29. The data processing system of claim 24, wherein the processor in determining a model of flow parameters determines a most probable model of flow parameters of the multiphase flow based on the determined flow vectors for the sequence of digital acoustic segments and the stored acoustic models of flow regime data in the flow conduit.

30. The data processing system of claim 24, wherein the processor in processing the feature vectors to determine a model of flow parameters performs Artificial Neural Network modeling.

31. The data processing system of claim 24, wherein the processor in processing the feature vectors to determine a model of flow parameters performs the steps of:
(a) receiving the feature vectors as input states for Artificial Neural Network processing;
(b) performing the Artificial Neural Network processing based on the input states to determine flow parameters of the model of multiphase flow; and
(c) providing as output states the determined flow parameters of the model of multiphase flow.

32. The data processing system of claim 24, wherein the processor in processing the feature vectors to determine a model of flow parameters performs Hidden Markov modeling and Artificial Neural Network modeling.

33. The data processing system of claim 24, wherein the processor further forms a training model for performing the step of processing the feature vectors.

34. The data processing system of claim 24, wherein the processor further stores the formed training model in the memory.

35. The data processing system of claim 24, wherein the processor further provides the determined model of flow parameters of the multiphase flow for display.

36. A data storage device having stored in a non-transitory computer readable medium computer operable instructions for causing a data processing system to determine in a processor of the data processing system flow parameters of multiphase flow of fluids in a flow conduit based on acoustic emissions from the multiphase flow and acoustic models of flow regime data in the conduit stored in a database of the computer, the instructions stored in the data storage device causing a processor in the data processing system to perform the following steps:
(a) segmenting the acoustic emission signals into a sequence of digital acoustic emission segments;
(b) determining a feature vector for each of the sequence of digital acoustic emission segments;
(c) processing the feature vectors to determine a model of flow parameters of the multiphase flow.

37. The data storage device of claim 36, wherein the data memory stores a database of actual multiphase flow conditions, and wherein the instructions further comprise instructions causing the processor to perform the step of processing the feature vectors to determine a model of flow parameters based on actual multiphase flow conditions data from the database.

38. The data storage device of claim 36, wherein the instructions for processing the feature vectors to determine a model of flow parameters comprise instructions to perform Hidden Markov modeling.

39. The data storage device of claim 36, wherein the instructions for processing the feature vectors to determine a model of flow parameters comprise instructions to perform the step of:
determining a model of flow parameters of the multiphase flow based on the determined flow vectors for the sequence of digital acoustic segments and the stored acoustic models of flow regime data in the flow conduit.

40. The data storage device of claim 36, wherein the instructions for processing the feature vectors to determine a model of flow parameters comprise instructions to perform the step of:
determining a most probable model of flow parameters of the multiphase flow based on the determined flow vectors for the sequence of digital acoustic segments and the stored acoustic models of flow regime data in the flow conduit.

41. The data storage device of claim 36, wherein the instructions for processing the feature vectors to determine a model of flow parameters comprise instructions to perform Artificial Neural Network modeling.

42. The data storage device of claim 36, wherein the instructions for processing the feature vectors to determine a model of flow parameters comprise instructions to perform the steps of:
(a) receiving the feature vectors as input states for Artificial Neural Network processing;
(b) performing the Artificial Neural Network processing based on the input states to determine flow parameters of the model of multiphase flow; and
(c) providing as output states the determined flow parameters of the model of multiphase flow.

43. The data storage device of claim 36, wherein the instructions for processing the feature vectors to determine a model of flow parameters comprise instructions to perform Hidden Markov modeling and Artificial Neural Network modeling.

44. The data storage device of claim 36, wherein the instructions further comprise instructions to perform the step of forming a training model for performing the step of processing the feature vectors.

45. The data storage device of claim 36, wherein the instructions further comprise instructions to perform the step of storing the formed training model in the memory of the computer.

46. The data storage device of claim 36, wherein the instructions further comprise instructions to perform the step of providing the determined model of flow parameters of the multiphase flow for display.
